(19) United States
(12) Patent Application Publication
(10) Pub. No.: US 2009/0165939 A1
(43) Pub. Date: Jul. 2, 2009

(54) METHOD OF MANUFACTURING A COMPLEX INCLUDING A SUPPORT LAYER HAVING A SPECIFIC TEXTURE

(75) Inventors: Olivier Ferrand, Le Cheylard (FR); Philippe Sanial, Vernoux En Vivarais (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Textitles ET Plastiques Chomarat, Le Cheylard (FR)

(21) Appl. No.: 12/296,510

(22) PCT Filed: Apr. 5, 2007
(86) PCT No.: PCT/FR2007/051079

§ 371 Date: Oct. 8, 2008

(30) Foreign Application Priority Data
Apr. 10, 2006 (FR) 0651295

(51) Int. Cl. B32B 37/26

(52) U.S. Cl. 156/244.16; 156/244.27; 156/244.25

(57) ABSTRACT

A method for manufacturing a complex including a support layer, based on a textile, a foam or a heavy mass, combined with a surface layer based on a polymeric material having a predefined surface state. The method of consisting of: (i) depositing a coating film of the said polymeric material of the surface layer on a sheet of paper having a surface state complementary to the predefined surface state of the complex to be obtained; (ii) calendering the support layer with an intermediate layer based on a second polymeric material obtained by extrusion upstream of the calender, and the assembly formed from the sheet of paper and the coating film; and (iii) withdrawing the sheet of paper.

### CROSS REFERENCE TO RELATED APPLICATION

This application is a National Stage filing under 35 U.S. C. §371 of PCT Application No. PCT/FR2007/051079, filed Apr. 5, 2007. This application also claims the benefit of French Application No. 0651295, filed Apr. 10, 2006. The entirety of both applications is incorporated herein by reference.

### FIELD OF THE INVENTION

The present invention relates to a method for manufacturing a multilayer complex, usable as a covering material in various sectors. Among the fields of application, mention can be made, in particular, of home furnishings, the automotive sector (e.g. for the decoration of the inside surfaces such as dashboards, doors and other), and the luggage sector.

The invention relates more particularly to a method for conferring on the complex a high quality surface state or texture, whether graining or glazing.

### BACKGROUND OF THE INVENTION

In general, materials used for covering applications, for example in the automotive or luggage field, comprise a support layer which provides, in particular, the mechanical strength of the assembly. This support layer is covered by a surface layer, prepared from a polymeric material, and which has the desired surface state, that is glazed or more or less grainy.

The materials usable to form the support layer may vary widely according to the function(s) that the covering material complementarily performs. Thus in the luggage field, to ensure good mechanical and tear strength, the support layer may be based on a textile, woven or knitted. In the field of decoration of the inside surfaces of vehicles, the support layer may include a foam for providing comfort through a degree of compressibility, and also acoustic insulation. When the covering is employed as a flooring or similar material, the support layer may consist of a heavy mass based on a composition of one or more polymeric materials, of the polyethylene type, including a fraction of mineral fillers, for example.

Among the techniques used to assemble the support layer and the surface layer, the most widespread consists in hot calendering, by the passage of the two superimposed layers between two rolls, of which at least one is heated. Such techniques are described, in particular, in documents EP-0 208 627, EP-0 986 463 or EP-1 448 383, in various configurations of complex composition. Advantageously, from the industrial standpoint, the support layer based on polymeric material can be extruded at the time of calendering, just in order to be superimposed on the support layer upstream of the calendering rolls.

Depending on the desired application, the surface state of the support layer may vary widely. Thus, it may be desirable in certain applications to obtain a perfectly smooth surface state, either with a glazed effect, in order to generate glints, or with a mat texture. For other applications, it may be desirable for the surface layer to have a grainy appearance, with patterns of which the shapes and dimensions may be selected in a very wide range. Such grainy appearances can be employed, in particular, in the field of luggage or the decoration of vehicle seats to impart a leatherlike appearance, with the many grain shapes that leather can assume.

This surface effect of the outer layer is conferred by the texture of the calendering roll which presses the outer layer. Thus, the generally metallic pressure roll has a texture or surface state that is complementary to the desired effect of the complex to be obtained. It is clear that the preparation by engraving of pressure rolls comprising this type of pattern is relatively costly. Such a drawback therefore also limits the possibility of varying the effects from one production to another, because it would then be necessary to have an array of rolls each comprising the desired patterns.

Another drawback of the technique employing engraved rolls stems from the fact that, on the complex obtained, the patterns must be repeated with a step equal to the circumference of the pressure roll. This poses a limitation to the production of completely random patterns. Furthermore, the imprints of the patterns on the roll must also have a continuity over the circumference of the said rolls.

Another major drawback encountered with the use of engraved rolls stems from the fact that the definition and detail of the patterns is limited to the detail of the engraving of the roll. Thus, it is not possible to produce extremely small patterns, because their technical production is either virtually unfeasible, or particularly costly. Moreover, with conventional calendering processes, it is necessary to have a coat of varnish after graining, which alters the surface state obtained by the grained rolls.

### SUMMARY OF THE INVENTION

It is an object of the invention to provide a method for obtaining a grain fineness and, more generally, a quality of surface state that is significantly superior to what would be obtained with engraved roll calenders. Another object is to obtain very flexible products, having good chemical resistance and mechanical strength.

A further object of the invention is to provide for a wide variety of feasible patterns by eliminating the drawback resulting from the use of engraved rolls.

The invention therefore relates to a method for manufacturing a complex including a support layer combined with a surface layer. The support layer may be based on a textile, a foam or even a heavy mass, while the surface layer is based on a polymeric material, and has a predefined surface state, of the glazed, grainy, mat or glossy type.

According to the invention, this method is characterized in that it consists of:
depositing a coating film of the polymeric material of the surface layer, on a sheet of paper having a particular surface state, this surface state being complementary to the desired surface state of the complex to be obtained;
calendering the support layer with an intermediate layer based on a second polymeric material obtained by extrusion upstream of the calender, and the assembly formed from the sheet of paper and the coating film; and
withdrawing the sheet of paper, in order to allow the appearance, on the surface layer, of the texture imprinted in the material of the surface layer by the texture of the paper sheet.

In other words, the invention consists of using a paper having a predefined texture, with wide variety and considerable detail, in order to generate complementary patterns on the coating film during the calendering operation. The peeling of the characteristic sheet then serves to reveal the surface state on the outer layer. Although the depth of the patterns thus obtained is slightly lower than that which can be obtained with engraved rolls, the method is particularly advantageous insofar as the fineness of the patterns obtained is, on the other hand, far superior to what can be obtained with engraved rolls. In fact, negative patterns on the characteristic sheet of paper are produced by specific engraving processes, which serve to obtain extremely advantageous levels of detail.

Another advantage of the invention resides in the use of a conventional calendering system, in which the rolls employed are completely smooth, because the surface effect is created by the texture of the characteristic sheet of paper.

In practice, the surface layer is combined with the support layer by the use of an intermediate layer, based on another polymeric material. Thus, the support layer receives this intermediate layer which, itself, comes into contact with the chemical binder deposited under the coating film that forms the future surface layer. The use of this intermediate layer serves to bond the support layer to the surface layer, and to provide volume to the complex thus obtained. This intermediate layer is obtained by extrusion, just before being complexed between the support layer and the paper coated with the coating film. In this case, insofar as it is at a high temperature, corresponding to that of the extruder outlet, the heat input provided facilitates the complexation between the various layers. It is thereby possible to use a calender at a temperature of a few tens of degrees (° C.), much lower than the temperature of the calenders used for co-lamination processes.

This intermediate layer may be a multilayer. It may, for example, consist of several elementary layers co-extruded upstream of the calender.

As already stated, the use of the characteristic paper serves to obtain multiple surface states, according to whether the sheet of paper is smooth or grainy.

In practice, in the case in which the coating film and the intermediate layer are chemically incompatible, it may be useful to deposit a chemical binder on the face of the coating film intended to be in contact with the intermediate layer.

This chemical binder may be deposited on the coating film by a photogravure process, serving to accurately determine the quantity of binder necessary to bond the coating film to the support layer, or the intermediate layer as applicable.

In practice, various materials can be employed to form the outer coating film, depending on the materials of the intermediate layer. Thus, in the case in which the intermediate layer is based on a thermoplastic resin, including polyolefins for example, the coating film forming the surface layer may be based on polyurethane. It is also possible to use intermediate layers based on plasticized materials, of the polyvinyl chloride type. In this case, the usable coatings may be of the acrylic or polyurethane type, or even resins based on fluorinated components or silicone or other, depending on the applications.

### BRIEF DESCRIPTION OF THE FIGURES

The manner of implementing the invention, and the advantages thereof, will appear clearly from the description of the embodiment that follows, provided as an example, in conjunction with the appended figure.

FIG. 1 is a schematic representation of an installation implementing the inventive method.

### DETAILED DESCRIPTION OF THE INVENTION

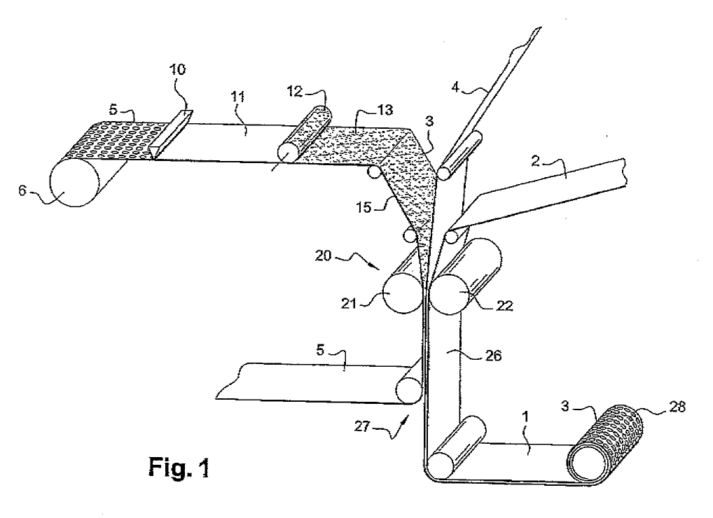

As shown in FIG. 1, the inventive method serves to produce a complex (1), associating a support layer (2), in combination with an intermediate layer (4), and using a sheet of paper (5) having a predefined surface state. More precisely, the method consists in initially coating the sheet of paper (5) reeled out from the roll (6) at the coating station (10). More precisely, the upper face, which is covered with the coating film, has a specific surface state, which may be smooth, mat or grainy as shown schematically in FIG. 1. The station (10) therefore allows the deposition of a coating film (11), typically based on a material of the acrylic or polyurethane type.

The coating film may be deposited in several successive elementary coats. In one particular embodiment, the deposition of a first elementary coat is intended to partially fill the spaces between the reliefs of the grain of the paper. This first elementary coat is produced with a material having a first colour. The deposition of a second elementary coating layer, with a material of another colour, serves to produce “two-tone” effects on the complex.

In the case in which it is incompatible with the intermediate layer, this coating film, having a typical thickness of between 10 and 50 μm, receives the deposition of a chemical binder (13) at the station (12). This binder has the function of allowing the adhesion of the coating film (11) to the intermediate layer. This chemical binder is deposited by a 1000 points photogravure technique, or more generally by any technique serving to obtain a good distribution of this chemical binder on the visible face of the coating film (11). The coating film must be as flat as possible, and no longer allow the reliefs of the grains of the paper to appear, so that the binder is optimally deposited. Typically, the chemical binder is advantageously based on compounds including polar sites, such as acid functions, esters, or chlorinated sites.

Thus, the assembly (15) formed from the sheet of paper (5), the coating film (11) covered with the binder (13) arrives at the calendering station (20).

The support layer (2) which, as stated above, may be varied in nature, and in particular include textiles, foams or heavy masses, is also conveyed to the calendering station (20). In the example shown, an intermediate layer (4) based on thermoplastic material of the PVC, polyolefin or other type, is also conveyed to the calendering station (20). This intermediate layer can be obtained by extrusion directly upstream of the calender. In this case, the heat required for complexing is partly provided by this intermediate layer during cooling, since the intermediate layer leaves the extruder at a high temperature, about 170° C. for PVC, and 230° C. for polyolefin bases.

The calendering station (20) has various pressure rolls, of which the spacing is determined according to the desired thickness of the future complex. The rolls (21, 22) have different hardnesses to absorb variations in thickness of the complex during formation. In particular, one roll may be metallic, and the other may have a rubberized coating. These rolls have a smooth outer surface, and more generally, a surface state that is not really optimized, insofar as it has no direct effect on the surface effect of the final complex. One and/or the other of these rolls can be temperature-controlled, to maintain the complex at an optimal temperature.

At the exit of the calendering station (20), the assembly (26), thus including the support layer (2) calendered with the intermediate layer (3) and the assembly (15), reaches a peeling station (27), where the sheet of paper (5) is removed. The complex (1) thus obtained can be rewound, and the surface layer (3) then has a surface appearance (28) complementary to that of the sheet of paper (5). The paper can thus be used again later.

By way of example, complexes can be produced having a very wide range of grain fineness of the type known as the “Lotus effect”.

The exemplary embodiments below are provided for illustration, and do not limit the scope of the invention.

### EXAMPLE 1

The following are selected:
support layer, a 180 g/m² jersey textile;
intermediate layer, a 300 g/m² TPO;
binder, a modified polyolefin with a weight of 5 g/m²;
coating film, a 20 g/m² polyurethane.

The temperature at which the material reaches the calender is close to 210° C., for a travel speed of a few metres per minute.

The paper has a “leather” type grain. The complex obtained can be used in the field of home furnishings, automotive, for example for producing gearshift bellows.

### EXAMPLE 2

The following are selected:
support layer, a crosslinked polyolefin foam, thickness 2.5 mm, density 67 kg/m³;
intermediate layer, a 400 g/m² TPO, dyed;
binder: a modified polyolefin, weight 5 g/m²;
coating film, a polyurethane, weight 20 g/m².

The temperature at which the material reaches the calender is close to 220° C., for a travel speed of a few metres per minute. The paper has a “technical” grain, that is having geometric patterns. The complex obtained can be used to produce vehicle dashboards.

It appears from the above that the method according to the invention has the significant advantage of allowing the production of surface effects with a fineness substantially higher than what is generally obtained with engraved or polished rolls.

The method also has the important advantage of being applicable on a calendering machine of which the rolls are smooth, therefore serving to obtain the various surface effects without replacement of the roll that is in contact with the surface layer.

1. A method for manufacturing a complex including a support layer, based on a textile, a foam or a heavy mass, combined with a surface layer based on a polymeric material having a predefined surface state, wherein the method consists of:
depositing a coating film of the said polymeric material of the surface layer on a sheet of paper having a surface state complementary to the predefined surface state of the complex to be obtained;
a calendering the support layer with an intermediate layer based on a second polymeric material obtained by extrusion upstream of the calender, and the assembly formed from the sheet of paper and the coating film;
a withdrawing the sheet of paper.

2. The method according to claim 1, wherein the intermediate layer is a multilayer.

3. The method according to claim 1, wherein the surface state of the sheet of paper is smooth.

4. The method according to claim 1, wherein the surface state of the sheet of paper is grainy.

5. The method according to claim 1, wherein the intermediate layer is based on a thermoplastic resin, including polyolefins.

6. The method according to claim 1, wherein the intermediate layer is based on a plasticized material, of the polyvinyl chloride type.

7. The method according to claim 1, wherein the coating film is based on a material selected from the group comprising acrylics and polyurethanes.

8. The method according to claim 1, wherein a chemical binder is deposited on a face of the coating film intended to be in contact with the intermediate layer.

9. The method according to claim 8, wherein the chemical binder is deposited by photogravure.
